(19) United States
(12) Patent Application Publication
(10) Pub. No.: US 2014/0232634 A1
(43) Pub. Date: Aug. 21, 2014

(54) TOUCH-BASED GESTURES MODIFIED BY GYROSCOPE AND ACCELEROMETER

(71) Applicant: APPLE INC., Cupertino, CA (US)

(72) Inventors: Patrick S. Piemonte, Cupertino, CA (US); Marcel van Os, San Francisco, CA (US)

(73) Assignee: Apple Inc., Cupertino, CA (US)

(21) Appl. No.: 13/770,947

(22) Filed: Feb. 19, 2013

(51) Int. Cl. G06F 3/01

(52) U.S. Cl. CPC G06F 3/017
USPC 345/156

(57) ABSTRACT

A mobile device including a touchscreen display presents an image of a three-dimensional object. The display can concurrently present a user interface element that can be in the form of a virtual button. While the device's user touches and maintains fingertip contact with the virtual button via the touchscreen, the mobile device can operate in a special mode in which physical tilting of the mobile device about physical spatial axes causes the mobile device to adjust the presentation of the image of the three-dimensional object on the display, causing the object to be rendered from different viewpoints in the virtual space that the object virtually occupies. The mobile device can detect such physical tilting based on feedback from a gyroscope and accelerometer contained within the device.

### BACKGROUND

The present disclosure relates generally to mobile devices, and in particular to techniques for manipulating mobile device user interfaces based on user interactions with those mobile devices.

A mobile device (also known as a handheld device, handheld computer, or simply handheld) can be a small, hand-held computing device, typically having a display screen with touch input and/or a miniature keyboard. A handheld computing device has an operating system (OS), and can run various types of application software, sometimes called “apps.” Most handheld devices can also be equipped with Wi-Fi, Bluetooth, and global positioning system (GPS) capabilities. Wi-Fi components can allow wireless connections to the Internet. Bluetooth components can allow wireless connections to other Bluetooth capable devices such as an automobile or a microphone headset. A camera or media player feature for video or music files can also be typically found on these devices along with a stable battery power source such as a lithium battery. Mobile devices often come equipped with a touchscreen interface that acts as both an input and an output device.

Mobile phones are a kind of mobile device. A mobile phone (also known as a cellular phone, cell phone, or hand phone) is a device that can make and receive telephone calls over a radio link while moving around a wide geographic area. A mobile phone can do so by connecting to a cellular network provided by a mobile phone operator, allowing access to the public telephone network. In addition to telephony, modern mobile phones can often also support a wide variety of other services such as text messaging, multimedia messaging service (MMS), e-mail, Internet access, short-range wireless communications (infrared, Bluetooth, etc.), business applications, gaming, and photography. Mobile phones that offer these and more general computing capabilities are often referred to as smart phones.

The Apple iPhone, in its various generations, is a smart phone. The iPhone includes a variety of components, such as a GPS, an accelerometer, a compass, and a gyroscope, which the iPhone's OS can use to determine the iPhone's current location, orientation, speed, and attitude. The iPhone's OS can detect events from these components and pass these events on to applications that are executing on the iPhone. Those applications can then handle the events in a manner that is custom to those applications. For example, using its built-in components, the iPhone can detect when it is being shaken, and can pass an event representing the shaking on to applications that have registered to listen for such an event. An application can respond to that event, for example, by changing the images that the iPhone is currently presenting on its touchscreen display.

Like many mobile devices, the iPhone, and its cousins the iPad and iPod Touch, come equipped with a touchscreen interface that can detect physical contact from a user of the mobile device and generate a corresponding event. For example, the iPhone can detect when a user has single-tapped the screen, double-tapped the screen, made a pinching motion relative to the screen, made a swiping motion across the screen, or made a flicking motion on the screen with his fingertips. Each such user interaction relative to the iPhone can cause a different kind of corresponding event to be generated for consumption by interested applications. Thus, the iPhone, iPad, and iPod Touch are able to detect and respond to a variety of physical interactions that a user can take relative those devices.

A mobile device's touchscreen is usually the primary mechanism by which the mobile device's user interacts with user interface elements (e.g., icons) that are displayed on the touchscreen. Thus, if a user desires to launch an application, the user might tap on the application's icon shown on the mobile device's display. Alternatively, if a user desires to move an icon from one location to another in the user interface, the user might press down on that icon's location on the display and then slide his fingertip across the touchscreen to the destination at which the user wants the icon to be placed. A user of a more conventional computer, such as a desktop computer, would likely use a separate pointing device such as a mouse to perform similar operations.

### BRIEF DESCRIPTION OF THE DRAWINGS

FIG. 1 is a block diagram of a computer system according to an embodiment of the present invention.

FIG. 2 is a block diagram illustrating an example of an initial physical orientation of a mobile device relative to a physical spatial axis that passes horizontally across a center of a touchscreen display of the mobile device, according to an embodiment of the invention.

FIG. 3 is a block diagram illustrating an example of a subsequent physical orientation of a mobile device relative to a physical spatial axis that passes horizontally across a center of a touchscreen display of the mobile device, according to an embodiment of the invention.

FIG. 4 is a flow diagram illustrating an example of a technique for rendering a three-dimensional object on a mobile device's display from a perspective that depends on an extent to which the mobile device has been tilted along a horizontal axis from an initial physical orientation, according to an embodiment of the invention.

FIG. 5 is a block diagram illustrating an example of an initial physical orientation of a mobile device relative to a physical spatial axis that passes vertically across a center of a touchscreen display of the mobile device, according to an embodiment of the invention.

FIG. 6 is a block diagram illustrating an example of a subsequent physical orientation of a mobile device relative to a physical spatial axis that passes vertically across a center of a touchscreen display of the mobile device, according to an embodiment of the invention.

FIG. 7 is a flow diagram illustrating an example of a technique for continuously rotating a viewpoint, from whose perspective a virtual scene is re-rendered, about a focal point in a direction and speed that varies based on an extent to which the mobile device has been tilted along a vertical axis from an initial physical orientation, according to an embodiment of the invention.

FIG. 8 is a flow diagram illustrating a technique according to an embodiment of the invention.

### DETAILED DESCRIPTION

Embodiments of the invention can involve a mobile device that includes a touchscreen display that presents an image of a three-dimensional object. The display can concurrently present a user interface element that can be in the form of a virtual button. While the device's user touches and maintains fingertip contact with the virtual button via the touchscreen, the mobile device can operate in a special mode in which physical tilting of the mobile device about physical spatial axes causes the mobile device to adjust the presentation of the image of the three-dimensional object on the display, causing the object to be rendered from different viewpoints in the virtual space that the object virtually occupies. The mobile device can detect such physical tilting based on feedback from a gyroscope and accelerometer contained within the device.

For example, in one embodiment, while the virtual button is being contacted, a mobile device can operate in a special mode in which physical tilting of the device along a physical spatial axis that passes horizontally across the device's display causes the device to render the three-dimensional object at a different angle relative to a virtual plane on which the three-dimensional object virtually sits. Such tilting essentially can cause the device to position the rendering viewpoint relative to the object closer to a top-view or closer to a side-view of that object, depending on whether the tilting physically moves the top or bottom of the display away from or toward the viewer, while maintaining constant the virtual distance of the rendering viewpoint from the object.

For another example, in one embodiment, while the virtual button is being contacted, a mobile device can operate in a special mode in which physical tilting of the device along a physical spatial axis that passes vertically across the device's display causes the device to render the three-dimensional object at a different angle relative to a virtual spatial axis that passes through the three-dimensional object perpendicular to the virtual plane on which the object virtually sits. Such tilting essentially can cause the device to rotate the rendering viewpoint relative to the object about this virtual spatial axis continuously at some speed and counter-directionally to the tilt for as long as the device remains tilted, while maintaining constant the virtual distance of the rendering viewpoint from the object, so that various different sides of the object become rendered on the display during the rotation. When the device is restored to the initial orientation that the device possessed prior to the tilting, the device can cease the continuous rotation of the rendering viewpoint about the spatial axis so that the object appears to stop rotating.

In one embodiment, the special mode discussed above is only active while fingertip contact with the virtual button via the touchscreen is being maintained. In such an embodiment, tilting of the device while the special mode is inactive might not cause the object to become rendered differently as discussed above. However, in an alternative embodiment of the invention, the special mode discussed above is active at all times. In such an alternative embodiment, the display can completely omit the virtual button, and tilting of the device can cause the object to become rendered differently whenever the device is tilted while the object is being displayed.

The following detailed description together with the accompanying drawings will provide a better understanding of the nature and advantages of the present invention.

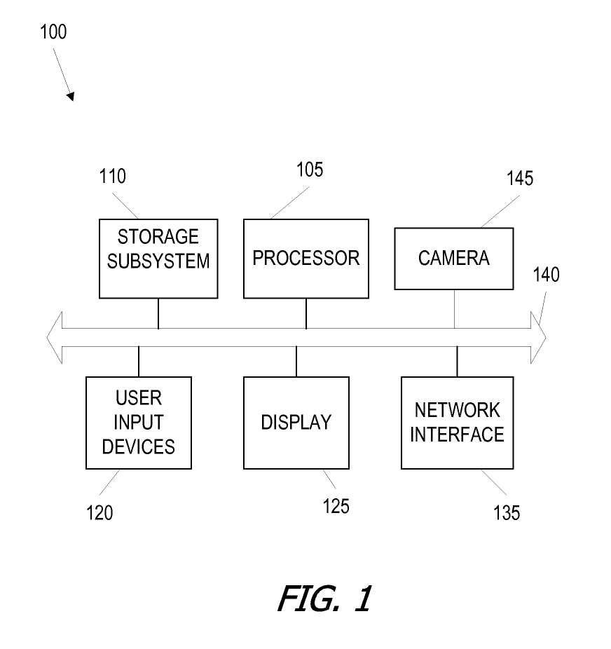

FIG. 1 illustrates a computing system 100 according to an embodiment of the present invention. Computing system 100 can be implemented as any of various computing devices, including, e.g., a desktop or laptop computer, tablet computer, smart phone, personal data assistant (PDA), or any other type of computing device, not limited to any particular form factor. Computing system 100 can include processing unit(s) 105, storage subsystem 110, input devices 120, display 125, network interface 135, and bus 140. Computing system 100 can be an iPhone or an iPad.

Processing unit(s) 105 can include a single processor, which can have one or more cores, or multiple processors. In some embodiments, processing unit(s) 105 can include a general-purpose primary processor as well as one or more special-purpose co-processors such as graphics processors, digital signal processors, or the like. In some embodiments, some or all processing units 105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 105 can execute instructions stored in storage subsystem 110.

Storage subsystem 110 can include various memory units such as a system memory, a read-only memory (ROM), and a permanent storage device. The ROM can store static data and instructions that are needed by processing unit(s) 105 and other modules of computing system 100. The permanent storage device can be a read-and-write memory device. This permanent storage device can be a non-volatile memory unit that stores instructions and data even when computing system 100 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 110 can include removable storage media that can be readable and/or writeable; examples of such media include compact disc (CD), read-only digital versatile disc (e.g., DVD-ROM, dual-layer DVD-ROM), read-only and recordable Blu-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 110 can store one or more software programs to be executed by processing unit(s) 105. “Software” refers generally to sequences of instructions that, when executed by processing unit(s) 105 cause computing system 100 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 110, processing unit(s) 105 can retrieves program instructions to execute and data to process in order to execute various operations described herein.

A user interface can be provided by one or more user input devices 120, display device 125, and/or and one or more other user output devices (not shown). Input devices 120 can include any device via which a user can provide signals to computing system 100; computing system 100 can interpret the signals as indicative of particular user requests or information. In various embodiments, input devices 120 can include any or all of a keyboard, touch pad, touch screen, mouse or other pointing device, scroll wheel, click wheel, dial, button, switch, keypad, microphone, and so on.

Display 125 can display images generated by computing system 100 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of display 125. Examples include indicator lights, speakers, tactile “display” devices, printers, and so on.

In some embodiments, the user interface can provide a graphical user interface, in which visible image elements in certain areas of display 125 are defined as active elements or control elements that the user can select using user input devices 120. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in display 125. Other user interfaces can also be implemented.

Network interface 135 can provide voice and/or data communication capability for computing system 100. In some embodiments, network interface 135 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 135 can provide wired network connectivity (e.g., Ethernet) in addition to or instead of a wireless interface. Network interface 135 can be implemented using a combination of hardware (e.g., antennas, modulators/demodulators, encoders/decoders, and other analog and/or digital signal processing circuits) and software components.

Bus 140 can include various system, peripheral, and chipset buses that communicatively connect the numerous internal devices of computing system 100. For example, bus 140 can communicatively couple processing unit(s) 105 with storage subsystem 110. Bus 140 also connects to input devices 120 and display 125. Bus 140 also couples computing system 100 to a network through network interface 135. In this manner, computing system 100 can be a part of a network of multiple computer systems (e.g., a local area network (LAN), a wide area network (WAN), an Intranet, or a network of networks, such as the Internet. Any or all components of computing system 100 can be used in conjunction with the invention.

A camera 145 also can be coupled to bus 140. Camera 145 can be mounted on a side of computing system 100 that is on the opposite side of the mobile device as display 125. Camera 145 can be mounted on the “back” of such computing system 100. Thus, camera 145 can face in the opposite direction from display 125.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 105 can provide various functionality for computing system 100. For example, processing unit(s) 105 can execute a device-orientation-sensitive three-dimensional object rendering application. In some embodiments, the device-orientation-sensitive three-dimensional object rendering application is a software-based process that can move the rendering viewpoint within the virtual space in which a three-dimensional virtual object virtually sits in order to cause the object to become rendered at a different angle on display 125; such movement of the viewpoint can be conducted in response to the physical tilting of the device out of some initial physical orientation.

It will be appreciated that computing system 100 is illustrative and that variations and modifications are possible. Computing system 100 can have other capabilities not specifically described here (e.g., mobile phone, global positioning system (GPS), power management, various connection ports for connecting external devices or accessories, etc.). Further, while computing system 100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

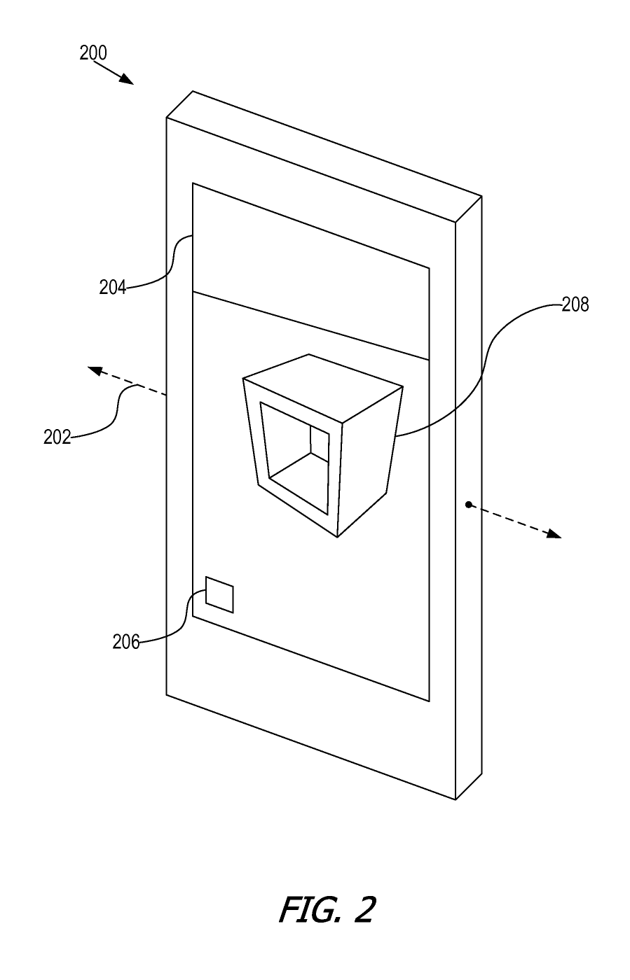

FIG. 2 is a block diagram illustrating an example of an initial physical orientation of a mobile device 200 relative to a physical spatial axis 202 that passes horizontally across a center of a touchscreen display 204 of mobile device 200, according to an embodiment of the invention. Mobile device 200 can be a smart phone such as an Apple iPhone, for example. Display 204 can depict a rendered three-dimensional object 208 as seen from an initial viewpoint in the virtual space that object 208 occupies. This initial viewpoint can be positioned at a particular distance from a focal point in the virtual space, and at an initial height above a virtual plane on which that focal point is located. The initial viewpoint can be imagined as being a point in virtual space at which a ray that extends from the focal point toward the viewer's eye passes through display 204. The focal point can be located at the base of object 208, for example, such that object 208 virtually sits upon the virtual plane on which the focal point is located. An initial viewing angle can be defined between (a) a ray that extends from the focal point through the initial viewpoint and (b) a ray that extends from the focal point to a point that is on the plane and directly above which the initial viewpoint hovers. As shown in FIG. 2, from the perspective of the initial viewpoint, a partially-side, partially-overhead view of object 208 can be apparent to the viewer due to the initial viewing angle.

Mobile device 200 initially can have an initial physical orientation at which device 200 is being held or otherwise positioned in physical space. This initial physical orientation can be defined based on the extent to which device 200 is initially physically tilted on physical spatial axis 202. For example, initially, device 200 might have a physical orientation that is described by device 200 being held absolutely upright, such that a vector initially referenced with respect to the direction of gravity passes through both the bottom and top surfaces of device 200, considered from the perspective of the viewer. An accelerometer within device 200 can be used to determine the initial physical orientation.

In one embodiment of the invention, display 204 can also depict a virtual button 206. In an embodiment, user fingertip-tapping upon virtual button 206 via touchscreen display 204 can cause an application executing on device 200 to perform some specified functionality, such as toggling in between a two-dimensional and three-dimensional view of the scene being rendered upon display 204. In such an embodiment, the continuous (e.g., lasting for more than a specified threshold amount of time) maintenance of user fingertip contact upon virtual button 206 can cause this application to perform an alternative specified functionality. This alternative specified functionality can involve placing the application into a special operational mode in which the physical tilting of device 200 along axis 202 causes device 200 to re-render object 208 continuously on display 204 in a manner that is based on the extent to which device 200 has been tilted from the initial physical orientation along axis 202. In an embodiment, device 200 can measure and store its initial physical orientation at a moment at which continuous maintenance of user fingertip contact on virtual button 206 begins. The application can remain within the special operational mode for as long as user fingertip contact is continuously maintained on virtual button 206 via touchscreen display 204. In one embodiment, when continuous user fingertip contact against virtual button 206 is detected, and when the initial physical orientation of mobile device 200 with respect to the direction of gravity is responsively determined, if there is any variation in the current orientation and a new position with respect to the direction of gravity before tilting movements begin, device 200 can animate the rendering of the scene into that position so there isn't any sudden “jump.”

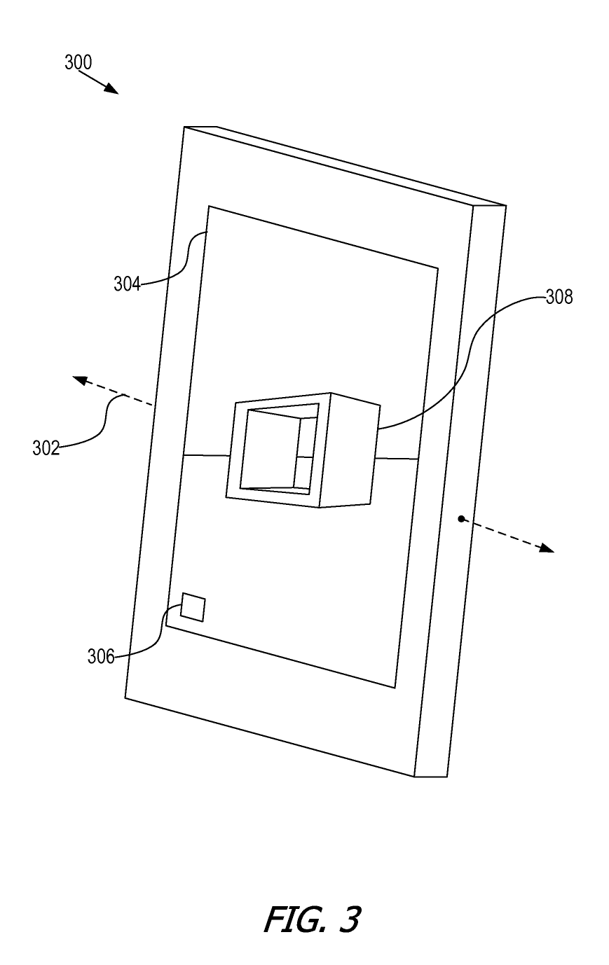

FIG. 3 is a block diagram illustrating an example of a subsequent physical orientation of a mobile device 300 relative to a physical spatial axis 302 that passes horizontally across a center of a touchscreen display 304 of mobile device 300, according to an embodiment of the invention. Mobile device 300 can be a smart phone such as an Apple iPhone, for example. Mobile device 300 can be the same mobile device 200 that is illustrated in FIG. 2, but tilted from the initial physical orientation described above to the subsequent physical orientation. Display 304 can depict a rendered three-dimensional object 308 as seen from a subsequent viewpoint in the virtual space that object 308 virtually occupies. This subsequent viewpoint can be positioned at the same particular distance from the same focal point discussed above in connection with FIG. 2, but at a different subsequent height above the virtual plane on which that focal point is located. Similar to the initial viewpoint, the subsequent viewpoint can be imagined as being a point in virtual space at which a ray, which extends from the focal point toward the viewer's eye, passes through display 304. A subsequent viewing angle can be defined between (a) a ray that extends from the focal point through the subsequent viewpoint and (b) a ray that extends from the focal point to a point that is on the plane and directly above which the subsequent viewpoint hovers. As shown in FIG. 3, from the perspective of the subsequent viewpoint, a completely- side view of object 308 can be apparent to the viewer due to the subsequent viewing angle. Object 308 can have the same three-dimensional model as object 208 that is discussed above in connection with FIG. 2, but rendered from the perspective of the subsequent viewpoint rather than the initial viewpoint.

As a consequence of tilting about physical spatial axis 302, mobile device 300 subsequently can have a subsequent physical orientation at which device 300 is being held or otherwise positioned in physical space. This subsequent physical orientation can be defined based on the extent to which device 300 has been physically tilted on physical spatial axis 302 from the initial physical orientation. For example, after some tilting along axis 302, device 300 might have a physical orientation that is described by device 300 being held such that the top surface of device 300 has been moved farther away from the viewer than the bottom surface of device 300 has been moved, relative to the initial physical orientation and considered from the perspective of the viewer. An accelerometer within device 300 can be used to determine the subsequent physical orientation.

In one embodiment of the invention, display 304 can also depict a virtual button 306 that can be the same as virtual button 206 described above in connection with FIG. 2. In an embodiment, the application that renders object 308 on display 304 can remain within the special operational mode for as long as user fingertip contact is continuously maintained on virtual button 306 via touchscreen display 304; once user fingertip contact on virtual button 306 is broken, the application can exit from the special operational mode. In an embodiment, while the application remains within the special operational mode, mobile device 300 continuously detects the extent to which device 300 has been tilted along axis 302 relative to the initial physical orientation, and re-renders object 308 on display 304 based on that extent. In an embodiment, as the extent to which device 300 is tilted from the initial physical orientation increases such that its top surface moves farther from, and/or its bottom surface moves closer toward, the viewer as considered from the viewer's perspective, the application can reduce the viewing angle defined above, such that the viewpoint remains the same distance from the focal point, but the viewing angle becomes more acute. The application can continuously re-render object 308 on display 304 based on the current viewpoint and the current viewing angle. Notably, throughout the re-rendering process, the focal point of the virtual scene being rendered can remain constant, and typically at the center of display 304, such that only the perspective from which the virtual scene (including object 308) is rendered changes as a consequence of the re-rendering process.

In an embodiment of the invention, as long as the physical orientation of mobile device 300 relative to axis 302 remains constant, the application does not continue to modify the viewing angle relative to the virtual plane on which the focal point sits, although the application can adjust the viewpoint in other respects, as will be discussed below. Thus, in such an embodiment of the invention, the application continues to alter the viewing angle relative to the virtual plane only as the user of device 300 is currently altering the extent to which device 300 is tilted along axis 302 from the initial physical orientation; in such an embodiment, while the user of device 300 is not currently altering the extent to which device 300 is tilted along axis 302 from the initial physical orientation (though device 300 may remain in a tilted position along axis 302 relative to the initial physical orientation), the application does not continue to alter the viewing angle relative to the virtual plane. The significance of this feature will become apparent in the discussion below regarding how, in one embodiment of the invention, a mobile device can respond to tilting along another different axis in a somewhat different manner.

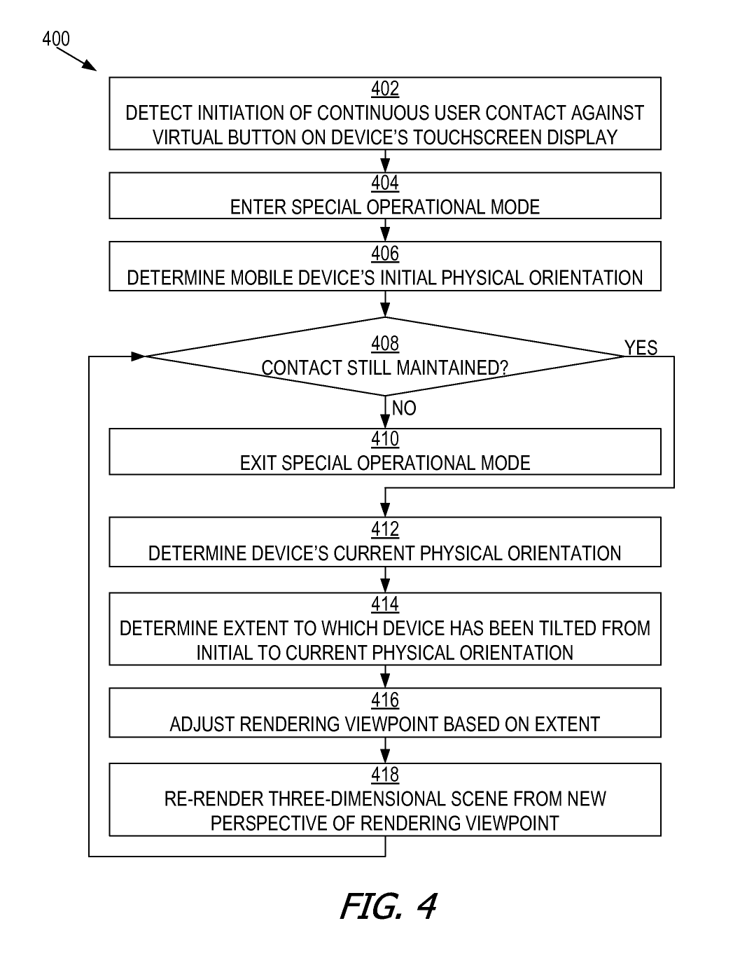

FIG. 4 is a flow diagram illustrating an example of a technique 400 for rendering a three-dimensional object on a mobile device's display from a perspective that depends on an extent to which the mobile device has been tilted along a horizontal axis from an initial physical orientation, according to an embodiment of the invention. For example, technique 400 can be performed by mobile device 200 of FIG. 2, or, more specifically, by an application program executing on mobile device 200 in conjunction with hardware components that detect changes in the physical orientation of mobile device 200 and send signals to that application program. Although certain operations are described as being performed in a certain order in technique 400, alternative embodiments of the invention can involve similar techniques being performed with fewer, additional, or different operations, and/or with those operations being performed in a different order.

In block 402, a mobile device can detect that continuous user contact has been initiated against a virtual button presented on the mobile device's touchscreen display. In block 404, in response to detecting that the continuous user contact has been initiated against the virtual button, the mobile device can enter a special operational mode. In block 406, the mobile device can determine an initial physical orientation of the mobile device relative to a physical spatial axis that passes horizontally through the left and right sides of the mobile device and through the center of the touchscreen display, from the perspective of the mobile device's viewer. In block 408, the mobile device can detect whether continuous user contact is still being maintained against the virtual button. If continuous user contact is still being maintained against the virtual button, then control passes to block 412. Otherwise, control passes to block 410.

In block 410, in response to a determination that continuous user contact is no longer being maintained against the virtual button, the mobile device can exit the special operational mode. Technique 400 then ends.

Alternatively, in block 412, in response to a determination that continuous user contact is still being maintained against the virtual button, the mobile device can determine a current physical orientation of the mobile device relative to the physical spatial axis. In block 414, the mobile device can determine an extent to which the mobile device has been tilted along the physical spatial axis from the initial physical orientation to the current physical orientation. In block 416, the mobile device can adjust a height of a rendering viewpoint from a virtual plane on which a focal point virtually sits, to an extent that is based on the extent determined in block 414, while maintaining a virtual distance of the rendering viewpoint from the focal point constant. This adjustment also modifies the viewing angle discussed above. However, in an embodiment, this adjustment only takes place if the current physical orientation has changed since the most recent re-rendering of the virtual scene shown on the mobile device's display.

In block 418, the mobile device can re-render, on the touchscreen display, from the perspective of the new position of the rendering viewpoint, a virtual three-dimensional scene that is focused on the focal point. The re-rendered virtual scene can appear from more of an overhead view or from more of a side view than in the virtual scene presented on the display prior to the most recent re-rendering depending on whether the mobile device has been tilted closer toward or farther away from its initial physical orientation on the physical spatial axis. Control then passes back to block 408.

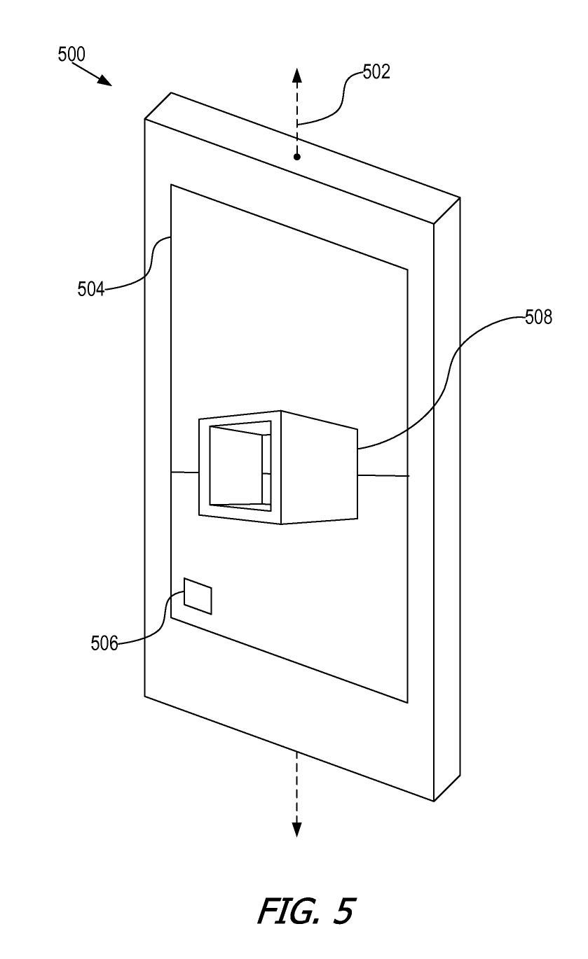

FIG. 5 is a block diagram illustrating an example of an initial physical orientation of a mobile device 500 relative to a physical spatial axis 502 that passes vertically across a center of a touchscreen display of mobile device 500, according to an embodiment of the invention. Mobile device 500 can be a smart phone such as an Apple iPhone, for example. Display 504 can depict a rendered three-dimensional object 508 as seen from an initial viewpoint in the virtual space that object 508 occupies. As in FIG. 2, this initial viewpoint can be positioned at a particular distance from a focal point in the virtual space, and at a particular height above a virtual plane on which that focal point is located. The initial viewpoint can be imagined as being a point in virtual space at which a ray that extends from the focal point toward the viewer's eye passes through display 504. The focal point can be located at the base of object 508, for example, such that object 508 virtually sits upon the virtual plane on which the focal point is located. The viewing angle can be established as a result of techniques discussed above in connection with FIGS. 2-4, for example. As shown in FIG. 5, from the perspective of the initial viewpoint, a two-sided view of object 508 can be apparent to the viewer.

Mobile device 500 initially can have an initial physical orientation at which device 500 is being held or otherwise positioned in physical space. This initial physical orientation can be defined based on the extent to which device 500 is initially physically tilted on physical spatial axis 502. For example, initially, device 500 might have a physical orientation that is described by device 500 being held perpendicular to the viewer, with little or no side-to-side tilt from the viewer's perspective, such that a vector emanating from the viewer is perpendicular to the touchscreen display surface of device 500. A gyroscope within device 500 can be used to determine the initial physical orientation. In one embodiment, a gyroscope within device 200 can provide raw angular rate data which can be combined with accelerometer data through a heavy sensor filtering. The combination of these sensors can output a device frame quaternion which device 500 can then use to calculate the tilt of device 500 from an initial reference position and which is also referenced with gravity.

In one embodiment of the invention, display 504 can also depict a virtual button 506, similar in appearance and functionality to virtual button 206 discussed above in connection with FIG. 2. In an embodiment, the continuous maintenance of user fingertip contact upon virtual button 506 can cause the rendering application to place the application into a special operational mode in which the physical tilting of device 500 along axis 502 causes device 504 to commence continuous rotation of the viewpoint about the focal point in a direction (e.g., clockwise or counter-clockwise) and at a speed that are based on the extent to which device 500 has been tilted from the initial physical orientation along axis 502, while concurrently maintaining constant both the viewing angle (i.e., relative to the plane on which the focal point virtually sits) and the current distance of the viewpoint from the focal point. As the continuous rotation of the viewpoint about the focal point occurs, the viewpoint can remain focused on the focal point, such that object 508 continuously remains within view. While this continuous rotation is occurring, device 504 can re-render object 508 continuously on display 504 from the perspective of each of the rotating viewpoint's new positions, thus causing different sides of object 508 to become apparent during the rotation. In an embodiment, device 500 can measure and store its initial physical orientation at a moment at which continuous maintenance of user fingertip contact on virtual button 506 begins. The application can remain within the special operational mode for as long as user fingertip contact is continuously maintained on virtual button 506 via touchscreen display 504.

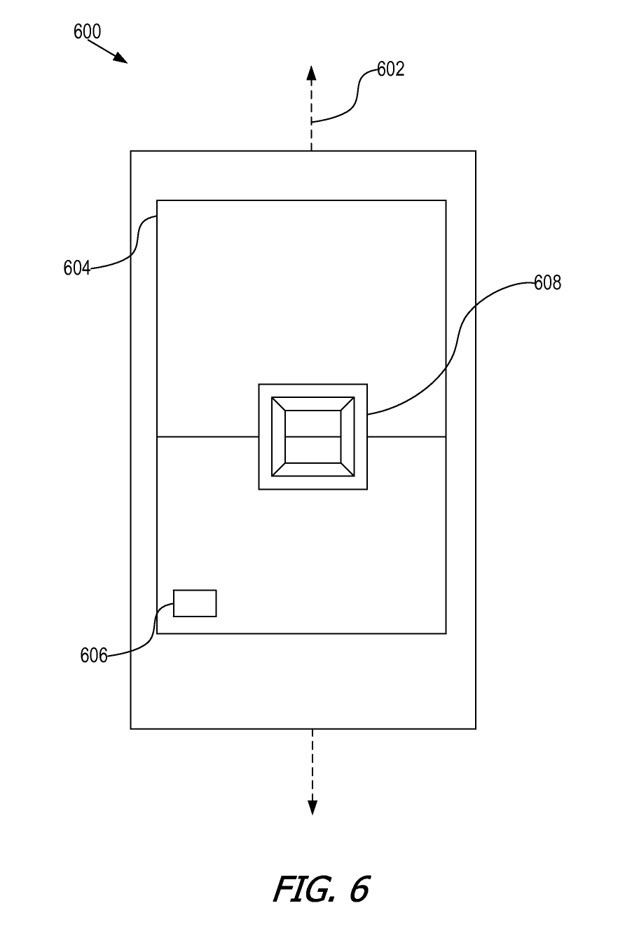

FIG. 6 is a block diagram illustrating an example of a subsequent physical orientation of a mobile device 600 relative to a physical spatial axis 602 that passes vertically across a center of a touchscreen display of mobile device 600, according to an embodiment of the invention. Mobile device 600 can be a smart phone such as an Apple iPhone, for example. Mobile device 600 can be the same mobile device 500 that is illustrated in FIG. 5, but tilted from the initial physical orientation described above to the subsequent physical orientation. Display 604 can depict a rendered three-dimensional object 608 as seen from a subsequent viewpoint in the virtual space that object 608 virtually occupies. This subsequent viewpoint can be positioned at the same particular distance from the same focal point discussed above in connection with FIG. 5, and at the same height above the virtual plane on which that focal point is located, such that the subsequent viewpoint is continuously, throughout the rotation, situated on another virtual plane that hovers at that height above and parallel to the virtual plane on which the focal point virtually sits. Inasmuch as the subsequent viewpoint continuously remains the same particular distance from the focal point throughout the rotation about the focal point, the subsequent viewpoint can be imagined as following a circular track that lies within this over-hovering parallel virtual plane. Similar to the initial viewpoint, the subsequent viewpoint can be imagined as being a point in virtual space at which a ray, which extends from the focal point toward the viewer's eye, passes through display 604. As shown in FIG. 6, from the perspective of the subsequent viewpoint, a single-sided view of object 608 can be apparent to the viewer due to the subsequent viewpoint's new position along the circular track. Object 608 can have the same three-dimensional model as object 608 that is discussed above in connection with FIG. 5, but rendered from the perspective of the subsequent viewpoint rather than the initial viewpoint.

As a consequence of tilting about physical spatial axis 602, mobile device 600 subsequently can have a subsequent physical orientation at which device 600 is being held or otherwise positioned in physical space. This subsequent physical orientation can be defined based on the extent to which device 600 has been physically tilted on physical spatial axis 602 from the initial physical orientation. For example, after some tilting along axis 602, device 600 might have a physical orientation that is described by device 600 being held such that the right-side surface of device 600 has been moved farther away from the viewer than the left-side surface of device 600 has been moved, relative to the initial physical orientation and considered from the perspective of the viewer. A gyroscope within device 600 can be used to determine the subsequent physical orientation.

In one embodiment of the invention, display 604 can also depict a virtual button 606 that can be the same as virtual button 506 described above in connection with FIG. 5. In an embodiment, the application that renders object 608 on display 604 can remain within the special operational mode for as long as user fingertip contact is continuously maintained on virtual button 606 via touchscreen display 604; once user fingertip contact on virtual button 606 is broken, the application can exit from the special operational mode. In an embodiment, while the application remains within the special operational mode, mobile device 600 can continuously detect the extent to which device 600 has been tilted along axis 602 relative to the initial physical orientation, and can continuously re-determine a rotation direction (e.g., clockwise or counter-clockwise, depending on whether device 600 has been tilted to the left or to the right) and a rotation speed based on that extent. The application can continuously move the viewpoint along the circular track discussed above, in the rotation direction and at the rotation speed. As the application moves the viewpoint along the circular track in this manner, the application can re-render object 608 on display 604 based on the viewpoint's new position. In an embodiment, as the extent to which device 600 is tilted from the initial physical orientation increases, such that one of its left-and-right-side surfaces moves farther from the viewer while the other of its left-and-right-side surfaces moves closer toward the viewer, as considered from the viewer's perspective, the application can increase the rotation speed discussed above, such that the viewpoint consequently moves more quickly along the circular track. The application can continuously re-render object 608 on display 604 based on the current viewpoint position on the circular track. Notably, throughout the re-rendering process, the focal point of the virtual scene being rendered can remain constant, and typically at the center of display 604, such that only the perspective from which the virtual scene (including object 608) is rendered changes as a consequence of the re-rendering process.

In an embodiment of the invention, even if the physical orientation of mobile device 600 relative to axis 602 remains constant, the application can continue to move the viewpoint along the circular track discussed above. Thus, in such an embodiment of the invention, the application continues to rotate the viewpoint about the focal point even if the user of device 600 is not currently altering the extent to which device 600 is tilted along axis 602 from the initial physical orientation; in such an embodiment, until the user of device 600 restores device 600 to its initial physical orientation relative to axis 602, or until the user releases contact from virtual button 606, the application can continue to move the viewpoint along the circular track. Thus, in an embodiment, a mobile device can respond to a tilting along one axis (e.g., axis 302) in a manner that only moves a viewpoint as the difference between the initial physical orientation and the subsequent physical orientation is currently changing, while the mobile device can respond to a tilting along another axis (e.g., axis 602) in a manner that moves that viewpoint even if the difference between the initial physical orientation and the subsequent physical orientation is not currently changing. In one embodiment of the invention, in response to the user of device 600 restoring device 600 to its initial physical orientation relative to axis 602, or in response to the user releasing contact from virtual button 606, the application can gradually decrease the rotation speed until the rendering viewpoint has stopped moving. The application thus can animate the slowing and stopping of the rotation. This embodiment may be contrasted to an alternative embodiment in which the application can abruptly stop the rotation without further animation.

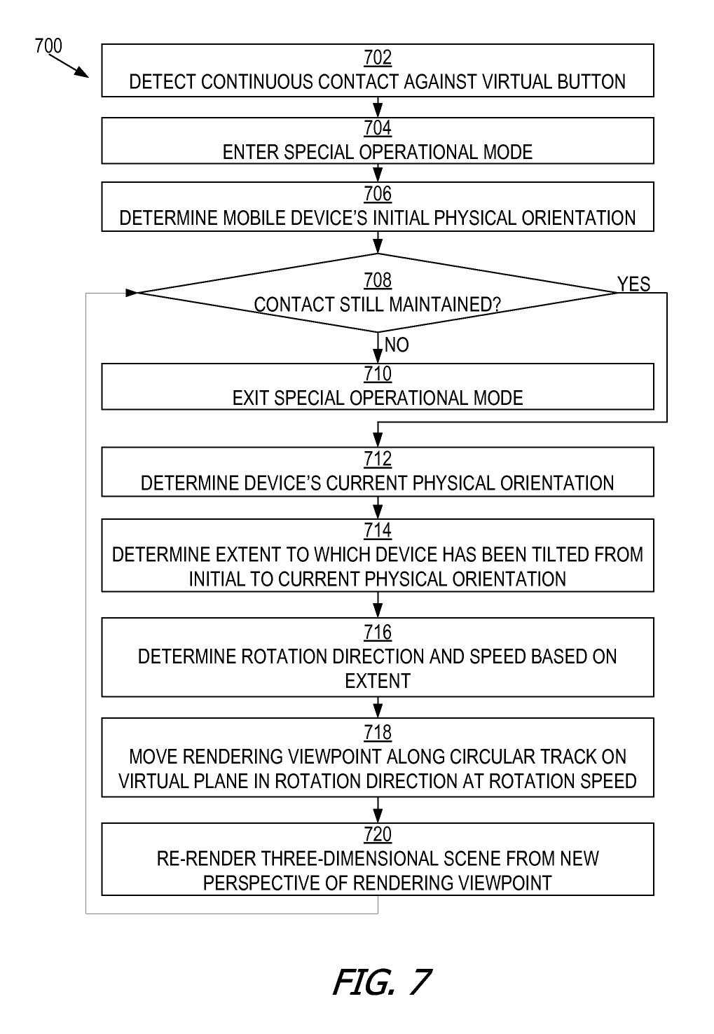

FIG. 7 is a flow diagram illustrating an example of a technique 700 for continuously rotating a viewpoint, from whose perspective a virtual scene is re-rendered, about a focal point in a direction and speed that varies based on an extent to which the mobile device has been tilted along a vertical axis from an initial physical orientation, according to an embodiment of the invention. For example, technique 700 can be performed by mobile device 500 of FIG. 5, or, more specifically, by an application program executing on mobile device 500 in conjunction with hardware components that detect changes in the physical orientation of mobile device 500 and send signals to that application program. Although certain operations are described as being performed in a certain order in technique 700, alternative embodiments of the invention can involve similar techniques being performed with fewer, additional, or different operations, and/or with those operations being performed in a different order.

In block 702, a mobile device can detect that continuous user contact has been initiated against a virtual button presented on the mobile device's touchscreen display. In block 704, in response to detecting that the continuous user contact has been initiated against the virtual button, the mobile device can enter a special operational mode. In block 706, the mobile device can determine an initial physical orientation of the mobile device relative to a physical spatial axis that passes horizontally through the top and bottom sides of the mobile device and through the center of the touchscreen display, from the perspective of the mobile device's viewer. In block 708, the mobile device can detect whether continuous user contact is still being maintained against the virtual button. If continuous user contact is still being maintained against the virtual button, then control passes to block 712. Otherwise, control passes to block 710.

In block 710, in response to a determination that continuous user contact is no longer being maintained against the virtual button, the mobile device can exit the special operational mode. Technique 700 then ends.

Alternatively, in block 712, in response to a determination that continuous user contact is still being maintained against the virtual button, the mobile device can determine a current physical orientation of the mobile device relative to the physical spatial axis. In block 714, the mobile device can determine an extent to which the mobile device has been tilted along the physical spatial axis from the initial physical orientation to the current physical orientation. In block 716, the mobile device can determine a rotation direction and a rotation speed based on the extent determine in block 714.

In block 718, the mobile device can move the rendering viewpoint from its current position to a new position along a circular track, which lies on a virtual plane that hovers over a virtual plane on which a focal point virtually sits, in the rotation direction and at the rotation speed determined in block 716, while maintaining a virtual distance of the rendering viewpoint from the focal point constant. In an embodiment, this movement is performed even if the current physical orientation has not changed since the most recent re-rendering of the virtual scene shown on the mobile device's display.

In block 720, the mobile device can re-render, on the touchscreen display, from the perspective of the new position of the rendering viewpoint, a virtual three-dimensional scene that is focused on the focal point. The re-rendered virtual scene can show different sides of a three-dimensional object in the virtual scene than were shown in the virtual scene presented on the display prior to the most recent re-rendering. Control then passes back to block 708.

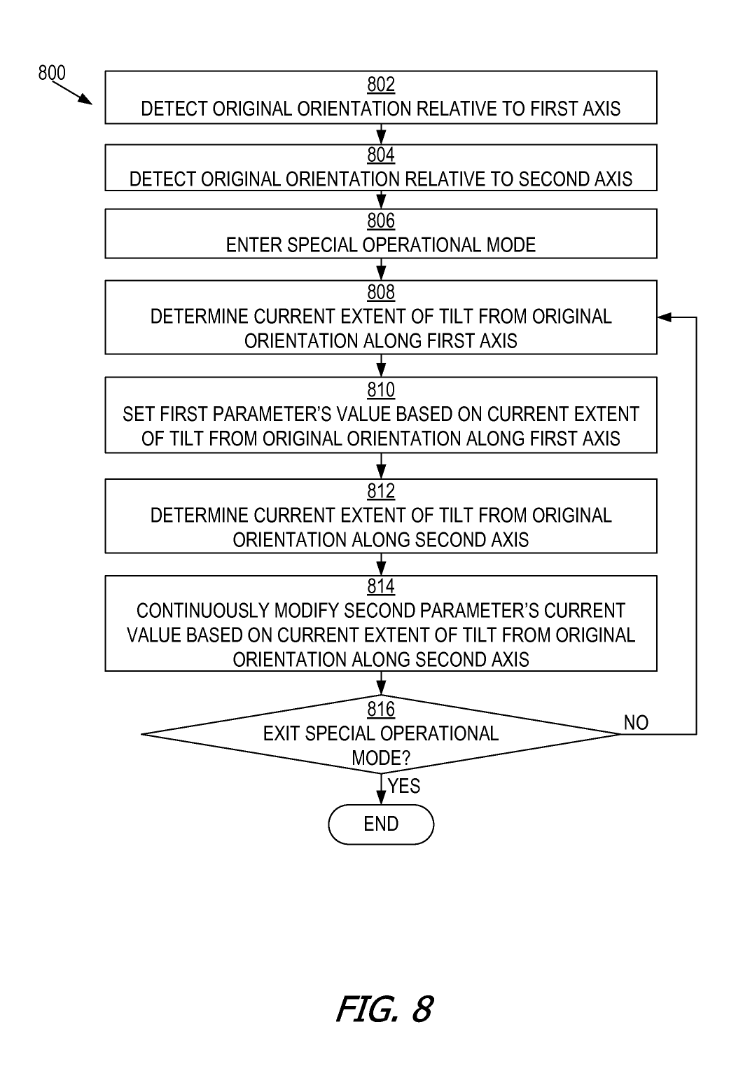

FIG. 8 is a flow diagram illustrating a technique 800 according to an embodiment of the invention. In block 802, original orientation relative to a first axis can be detected. In block 804, original orientation relative to a second axis can be detected. In block 806, special operational mode can be entered. In block 808, the current extent of title from the original orientation along the first axis can be determined. In block 810, a first parameter's value can be set based on the current extent of tilt from the original orientation along the first axis. In block 812, a current extent of tilt from the original orientation along the second axis can be determined. In block 814, a second parameter's current value can be continuously modified based on the current extent of tilt from the original orientation along the second axis. In block 816, a determination whether to exit special operational mode can be made. If yes, then technique 800 ends. If no, then control passes back to block 808.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer readable storage media; suitable media include magnetic disk or tape, optical storage media such as compact disk (CD) or DVD (digital versatile disk), flash memory, and other non-transitory media. Computer readable media encoded with the program code can be packaged with a compatible electronic device, or the program code can be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method comprising:
detecting that a mobile device has been tilted along a first axis;
in response to detecting that the mobile device has been tilted along the first axis, changing content being displayed by the mobile device by modifying an angle, relative to a focal point, at which the mobile device displays the content;
detecting that the mobile device has been tilted along a second axis that differs from the first axis; and
in response to detecting that the mobile device has been tilted along the second axis, changing the content being displayed by the mobile device by rotating, about the focal point, a viewpoint from which the mobile device displays the content while maintaining the angle of the view relative to the focal point.

2. The method of claim 1, wherein modifying the angle at which the mobile device displays the content comprises modifying the angle in response to determining that a user is maintaining contact with a virtual button being displayed by the mobile device.

3. The method of claim 1, wherein modifying the angle at which the mobile device displays the content comprises modifying the angle in response to determining that a user is maintaining contact with a virtual button that performs variant functionality based on whether the virtual button has been tapped or continuously contacted.

4. The method of claim 1, wherein detecting that the mobile device has been tilted along the first axis comprises detecting that an angle of a display of the mobile device initially referenced with respect to a direction of gravity has changed from an initial angle; and wherein modifying the angle at which the mobile device displays the content comprises re-rendering the content on the display to present a view of the content that includes more of a side view of a three-dimensional object than was previously displayed.

5. The method of claim 1, wherein modifying the angle at which the mobile device displays the content comprises modifying the angle only while the extent to which the mobile device tilts along the first axis is currently being changed.

6. The method of claim 1, wherein changing the content being displayed by the mobile device by rotating, about the focal point, the viewpoint from which the mobile device displays the content comprises continuously rotating the viewpoint about the focal point for as long as the mobile device remains tilted along the second axis from an initial physical orientation.

7. The method of claim 1, wherein changing the content being displayed by the mobile device by rotating, about the focal point, the viewpoint from which the mobile device displays the content comprises continuously rotating the viewpoint about the focal point for as long as the mobile device remains tilted along the second axis from an initial physical orientation that is established at a moment that the mobile device detects user contact against a particular user interface element.

8. The method of claim 1, wherein changing the content being displayed by the mobile device by rotating, about the focal point, the viewpoint from which the mobile device displays the content comprises continuously rotating the viewpoint about the focal point until an orientation of the mobile device is returned to an initial physical orientation in which the mobile device was oriented along the second axis prior to commencing the continuous rotating of the viewpoint.

9. The method of claim 1, wherein changing the content being displayed by the mobile device by rotating, about the focal point, the viewpoint from which the mobile device displays the content comprises continuously rotating the viewpoint about the focal point at a speed that varies based on an extent to which the mobile device is tilted along the second axis from an initial physical orientation.

10. The method of claim 1, wherein modifying the angle at which the mobile device displays the content comprises modifying the angle only while a physical orientation of the mobile device is currently being changed; and wherein changing the content being displayed by the mobile device by rotating, about the focal point, the viewpoint from which the mobile device displays the content comprises continuously rotating the viewpoint about the focal point even while the physical orientation of the movile device is not currently being changed.

11. The method of claim 1, wherein the first axis passes horizontally through a center of a display of the mobile device from a perspective of a viewer of the display; and wherein the first axis passes vertically through the center of the display of the mobile device from the perspective of the viewer of the display.

12. The method of claim 1, wherein changing the content being displayed by the mobile device by modifying the angle, relative to the focal point, at which the mobile device displays the content comprises re-rendering the content on a display from a perspective of the viewpoint while maintaining the focal point at a same position on the display; and wherein changing the content being displayed by the mobile device by rotating the viewpoint about the focal point, the viewpoint from which the mobile device displays the content comprises re-rendering the content on the display from the perspective of the viewpoint while maintaining the focal point at the same position on the display.

13. The method of claim 1, wherein detecting that the mobile device has been tilted along the first axis comprises detecting that the mobile device has been tilted along the first axis based on measurements obtained from an accelerometer of the mobile device; and wherein detecting that the mobile device has been tilted along the second axis comprises detecting that the mobile device has been tilted along the second axis based on measurements obtained from a gyroscope of the mobile device.

14. The method of claim 1, wherein rotating the viewpoint about the focal point while maintaining the angle of the view relative to the focal point comprises moving the viewpoint along a circular track that lies within a virtual plane that is parallel to a virtual plane on which the focal point sits; and further comprising gradually slowing to a stop the movement of the viewpoint along the circular track in response to detecting that the mobile device has been returned to an orientation that the mobile device possessed prior to the tilting along the second axis.

15. A computer-readable memory comprising particular instructions that are executable by one or more processors to cause the one or more processors to perform operations, the particular instructions comprising:
instructions to cause a computing device to detect that the computing device is being been tilted in a first direction;
instructions to cause the computing device to modify a first parameter only while the extent to which the device is being tilted in the first direction is currently changing;
instructions to cause the computing device to detect that the computing device has been tilted in a second direction that differs from the first direction; and
instructions to cause the computing device to continuously modify a second parameter until the computing device has stopped being tilted in the second direction.

16. The computer-readable memory of claim 15, instructions to cause the computing device to continuously modify the second parameter until the computing device has stopped being tilted in the second direction comprise instructions to cause the computing device to modify the second parameter until the computing device has been returned to an orientation that the computing device possessed prior to being tilted in the second direction.

17. The computer-readable memory of claim 15, wherein the instructions to cause the computing device to modify the first parameter only while the extent to which the device is being tilted in the first direction is currently changing comprise instructions to cause the computing device to cease changing the first parameter while an orientation of the computing device is not currently changing even though the orientation of the computing device remains different from an orientation that the computing device possessed prior to being tilted in the first direction.

18. The computer-readable memory of claim 15, wherein the instructions to cause the computing device to modify the first parameter involve calculating a new value for the first parameter based on a difference between an original orientation of the computing device and a current orientation of the computing device from top to bottom; and wherein the instructions to cause the computing device to modify the second parameter involve continuously adjusting the second parameter at a rate that is based on a difference between an original orientation of the computing device and a current orientation of the computing device from left side to right side.

19. The computer-readable memory of claim 15, wherein the first parameter is one of volume, brightness, and contrast; and wherein the second parameter is a different parameter than the first parameter.

20. A mobile device comprising:
an accelerometer to detect an extent to which the mobile device is tilted relative to a direction of gravity;
a gyroscope to detect an extent to which the mobile device is tilted unrelated to the direction of gravity; and
a memory storing a program that is configured to modify a first parameter based on a measurement from the accelerometer, and to modify a second parameter based on a measurement from the gyroscope.
